(19) United States
(12) Patent Application Publication
(10) Pub. No.: US 2026/0185920 A1
(43) Pub. Date: Jul. 2, 2026

(54) OPTICAL-VORTEX CONTROL DEVICE AND OPTICAL-VORTEX CONTROL METHOD

(71) Applicant: HAMAMATSU PHOTONICS K.K., Hamamatsu-shi, Shizuoka (JP)

(72) Inventors: Tomoko HYODO, Hamamatsu-shi, Shizuoka (JP); Taro ANDO, Hamamatsu-shi, Shizuoka (JP); Yoshiyuki OHTAKE, Hamamatsu-shi, Shizuoka (JP); Yu HASHIMOTO, Hamamatsu-shi, Shizuoka (JP)

(73) Assignee: HAMAMATSU PHOTONICS K.K., Hamamatsu-shi, Shizuoka (JP)

(21) Appl. No.: 18/859,670

(22) PCT Filed: Apr. 13, 2023
(86) PCT No.: PCT/JP2023/015035

§ 371 Date: Oct. 24, 2024

(30) Foreign Application Priority Data
May 2, 2022 (JP) 2022-075746

(51) Int. Cl. G01N 15/1434; G01N 15/10

(52) U.S. Cl. CPC G01N 15/1434; G01N 2015/1027; G01N 2015/144; G01N 2015/1447; G01N 2015/1454

(57) ABSTRACT

An optical vortex control apparatus is an apparatus for controlling a motion of a micro object in a medium in a sample, and includes a light source, an optical vortex generation unit, lenses, an aperture, a dichroic mirror, an illumination unit, an imaging unit, and a control unit. The objective lens focuses an optical vortex generated by the optical vortex generation unit on the micro object in the medium in the sample and irradiates the micro object with the optical vortex to optically trap the micro object. The imaging unit images the micro object optically trapped and driven, and outputs image data. The control unit analyzes the motion of the micro object based on the image data, adjusts a phase distribution of the optical vortex generated by the optical vortex generation unit based on an analysis result, and controls the motion of the micro object.

### TECHNICAL FIELD

The present disclosure relates to an optical vortex control apparatus and an optical vortex control method.

### BACKGROUND ART

There has been known a technique of optically trapping a micro object in a medium by an optical vortex. The optical vortex has a phase singularity on a propagation axis, and has a doughnut-shaped light intensity distribution in which a light intensity is zero on the propagation axis and the light intensity is at a maximum at a certain distance from the propagation axis.

In addition to the doughnut-shaped light intensity distribution, the optical vortex is also distinctive in that it has an orbital angular momentum. When the micro object in the medium is irradiated with the optical vortex which has the orbital angular momentum, the micro object receives the angular momentum from the optical vortex and rotates along an orbit having the large light intensity around the propagation axis. That is, the optical vortex is capable of optically trapping the micro object in the medium as well as of controlling the motion of the micro object.

Depending on a performance of an optical component provided in an optical system from a light source to the micro object and an adjustment accuracy at the time of optical system construction, the optical vortex with which the micro object is irradiated may not be a desired optical vortex, and the motion of the micro object may not be a desired motion. For example, even in the case in which it is desired to revolve the micro object on the orbit of a perfect circle shape at a constant speed, a motion trajectory of the micro object may have an elliptical shape or the speed may vary depending on the performance of the optical component and the adjustment accuracy at the time of the optical system construction.

Non Patent Documents 1 to 5 describe a technique for improving the accuracy of the optical trap by estimating an aberration of the optical system based on the intensity information of the optical vortex and performing aberration correction based on the estimation result. In the technique described in Non Patent Documents 4 and 5, machine learning is performed on the relationship between the aberration correction amount and the intensity information, and the aberration correction amount is obtained from the intensity information.

In a technique described in Non Patent Document 6, a modulation pattern which is presented on a modulation plane of a spatial light modulator is imaged on a sample plane, and the micro object on the sample plane is optically trapped and driven. Further, the modulation pattern is adjusted based on the intensity information of the optical vortex and the motion information of the micro object.

Specifically, a phase grating pattern is added to the modulation pattern which is presented on the modulation plane of the spatial light modulator based on the intensity information of the optical vortex, so that a light amplitude distribution on the sample plane is set to a desired distribution. In addition, a phase distribution is adjusted based on the motion information (specifically, an angular velocity distribution) of the micro object with respect to the modulation pattern which is presented on the modulation plane of the spatial light modulator, so that the motion of the micro object is set to a desired motion (specifically, the orbital angular momentum density distribution (OAM-density) is uniformized).

### CITATION LIST

### Non Patent Literature

Non Patent Document 1: S. N. Khonina, et al., “Strengthening the longitudinal component of the sharply focused electric field by means of higher-order laser beams”, Optics Letters, Vol. 38, No. 17, pp. 3223-3226, 2013
Non Patent Document 2: Y. Iketaki, et al., “Investigation of the center intensity of first- and second-order Laguerre-Gaussian beams with linear and circular polarization”, Optics Letters, Vol. 32, No. 16, pp. 2357-2359, 2007
Non Patent Document 3: Yansheng Liang, et al., “Aberration correction in holographic optical tweezers using a high-order optical vortex”, Applied Optics, Vol. 57, No. 13, pp. 3618-3623, 2018
Non Patent Document 4: Benjamin P. Cumming, et al., “Direct determination of aberration functions in microscopy by an artificial neural network”, Optics Express, Vol. 28, No. 10, pp. 14511-14521, 2020
Non Patent Document 5: Jin Li, et al., “Study on Aberration Correction of Adaptive Optics Based on Convolutional Neural Network”, Photonics, Vol. 8, 377, pp. 1-9, 2021
Non Patent Document 6: Mingzhou Chen, et al., “Dynamics of microparticles trapped in a perfect vortex beam”, Optics Letters, Vol. 38, No. 22, pp. 4919-4922, 2013

### SUMMARY OF INVENTION

### Technical Problem

In the technique described in Non Patent Documents 1 to 5, in order to acquire the intensity information of the optical vortex generated by an objective lens having a high NA, a high precision optical device and complicated post-processing are required, and thus, the above technique is not easy. The technique described in Non Patent Document 6 has the same problem as the above problem of the technique described in Non Patent Documents 1 to 5, and in addition, the adjustment of the modulation pattern which is presented on the modulation plane of the spatial light modulator is performed with two stages, and thus, the above technique is not easy also in this respect.

An object of an embodiment is to provide an optical vortex control apparatus and an optical vortex control method capable of easily generating a desired optical vortex.

### Solution to Problem

An embodiment is an optical vortex control apparatus. The optical vortex control apparatus includes a light source for outputting light; an optical vortex generation unit for generating an optical vortex from the light; a focusing optical system for focusing the optical vortex; an imaging unit for imaging a micro object optically trapped and driven by the optical vortex focused by the focusing optical system, and outputting image data; and a control unit for analyzing a motion of the micro object based on the image data, and adjusting a phase distribution of the optical vortex generated by the optical vortex generation unit based on an analysis result.

An embodiment is an optical vortex control method. The optical vortex control method uses a light source for outputting light; an optical vortex generation unit for generating an optical vortex from the light; and a focusing optical system for focusing the optical vortex, and the optical vortex control method includes an imaging step of imaging, by an imaging unit, a micro object optically trapped and driven by the optical vortex focused by the focusing optical system, and outputting image data; and a control step of analyzing a motion of the micro object based on the image data, and adjusting a phase distribution of the optical vortex generated by the optical vortex generation unit based on an analysis result.

### Advantageous Effects of Invention

According to the optical vortex control apparatus and the optical vortex control method of the embodiments, it is possible to easily generate a desired optical vortex.

### BRIEF DESCRIPTION OF DRAWINGS

FIG. 1 is a diagram illustrating a configuration of an optical vortex control apparatus 1.

FIG. 2 is a diagram for describing an optical trap of a micro object 91 by an optical vortex.

FIG. 3 is a diagram for describing the optical trap of the micro object 91 by the optical vortex.

FIG. 4 includes (a), (b) diagrams each showing an example of an intensity distribution of the optical vortex at a sample position.

FIG. 5 includes (a) a diagram showing a motion trajectory of the micro object before optical vortex generation adjustment in the case in which an objective lens A is used, and (b) a diagram showing the motion trajectory of the micro object after the optical vortex generation adjustment in the case in which the objective lens A is used.

FIG. 6 is a graph showing a torque distribution of the micro object before and after the optical vortex generation adjustment in the case in which the objective lens A is used.

FIG. 7 includes (a) a diagram showing the motion trajectory of the micro object before the optical vortex generation adjustment in the case in which an objective lens B is used, and (b) a diagram showing the motion trajectory of the micro object after the optical vortex generation adjustment in the case in which the objective lens B is used.

FIG. 8 is a graph showing the torque distribution of the micro object before and after the optical vortex generation adjustment in the case in which the objective lens B is used.

FIG. 9 includes (a) a diagram showing the motion trajectory of the micro object before the optical vortex generation adjustment in the case in which an objective lens C is used, and (b) a diagram showing the motion trajectory of the micro object after the optical vortex generation adjustment in the case in which the objective lens C is used.

FIG. 10 is a graph showing the torque distribution of the micro object before and after the optical vortex generation adjustment in the case in which the objective lens C is used.

FIG. 11 includes (a) a diagram showing the motion trajectory of the micro object before the optical vortex generation adjustment in the case in which an objective lens D is used, and (b) a diagram showing the motion trajectory of the micro object after the optical vortex generation adjustment in the case in which the objective lens D is used.

FIG. 12 is a graph showing the torque distribution of the micro object before and after the optical vortex generation adjustment in the case in which the objective lens D is used.

FIG. 13 includes (a) a diagram showing the motion trajectory of the micro object before the optical vortex generation adjustment in the case in which an objective lens E is used, and (b) a diagram showing the motion trajectory of the micro object after the optical vortex generation adjustment in the case in which the objective lens E is used.

FIG. 14 is a graph showing the torque distribution of the micro object before and after the optical vortex generation adjustment in the case in which the objective lens E is used.

FIG. 15 is a diagram showing an example of an adjustment pattern for the optical vortex generation adjustment.

FIG. 16 is a table showing an ellipticity and a variance value of the torque distribution before and after the optical vortex generation adjustment in the case in which each of the objective lenses A to E is used.

### DESCRIPTION OF EMBODIMENTS

Hereinafter, embodiments of an optical vortex control apparatus and an optical vortex control method will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

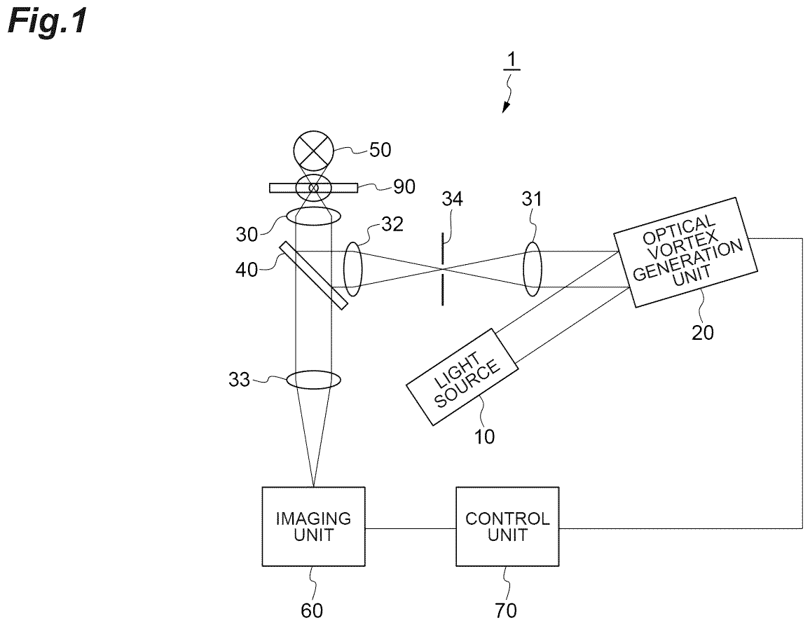

FIG. 1 is a diagram illustrating a configuration of an optical vortex control apparatus 1. The optical vortex control apparatus 1 is an apparatus for controlling a motion of a micro object in a medium in a sample 90, and includes a light source 10, an optical vortex generation unit 20, lenses 30 to 33, an aperture 34, a dichroic mirror 40, an illumination unit 50, an imaging unit 60, and a control unit 70.

The medium in the sample 90 is a liquid or a gas. A shape of the micro object in the medium is arbitrary, and the shape may be, for example, a sphere, a cube, a circular cone, or the like. A material of the micro object is also arbitrary, and the material may be, for example, a polystyrene bead, glass, crystal, or the like. The micro object has a size and a weight at a level to enable the micro object to be optically trapped by an optical vortex in the medium.

The light source 10 outputs light. The light source 10 is preferably a laser light source for generating coherent light. The light output from the light source 10 preferably has a wavelength at which heat absorption by the medium in the sample 90 is small.

The optical vortex generation unit 20 is optically coupled to the light source 10. The optical vortex generation unit 20 inputs the light output from the light source 10, and generates and outputs the optical vortex. The optical vortex which is generated by the optical vortex generation unit 20 is a light beam having a spiral wavefront, and is, for example, a Laguerre-Gaussian beam or a Bessel beam. As the optical vortex generation unit 20, a diffractive optical element, a spatial light modulator, or the like is preferably used.

The spatial light modulator has a plurality of pixels which are arrayed two-dimensionally, and is capable of modulating at least a phase of the light in each of the pixels and outputting the light. The spatial light modulator may also be capable of modulating an amplitude of the light in each of the pixels. By using the spatial light modulator described above as the optical vortex generation unit 20, it is possible to easily generate the optical vortex in various forms according to a set modulation pattern without changing the optical system, and a state of an optical trap of the micro object can be evaluated in various ways.

The spatial light modulator used as the optical vortex generation unit 20 may be a transmission type spatial light modulator or a reflection type spatial light modulator, and further, in the latter case, may be a liquid crystal on silicon-spatial light modulator (LCOS-SLM). In FIG. 1, the spatial light modulator of the reflection type is illustrated as the optical vortex generation unit 20. In FIG. 1, the light output from the light source 10 is obliquely incident on the optical vortex generation unit 20, and in addition, the light may be incident on the optical vortex generation unit 20 at a nearly vertical angle.

The lens 31, the aperture 34, the lens 32, the dichroic mirror 40, and the objective lens 30 constitute a focusing optical system for guiding the optical vortex output from the optical vortex generation unit 20 to the micro object in the medium in the sample 90.

A rear focal point position of the lens 31 and a front focal point position of the lens 32 coincide with each other. The aperture 34 has an aperture at the rear focal point position of the lens 31. The lens 31 and the lens 32 cause a modulation plane of the optical vortex generation unit 20 and a pupil plane of the objective lens 30 to have a positional relationship conjugate to each other, and form an image of the optical vortex output from the optical vortex generation unit 20 near the pupil plane of the objective lens 30.

The dichroic mirror 40 reflects the light arriving from the lens 32 to the objective lens 30. The objective lens 30 focuses the optical vortex on the micro object in the medium in the sample 90 and irradiates the micro object with the optical vortex to optically trap the micro object. It is also possible to control a rotational shape (circular orbit, elliptical orbit) of the micro object by arranging a 2/4 plate or a 2/2 plate on an optical path of the optical vortex before the optical vortex is incident on the objective lens 30.

The illumination unit 50 is provided on a side opposite to the objective lens 30 with the sample 90 interposed therebetween, and outputs illumination light to the sample 90. It is preferable that the illumination unit 50 outputs the light having a wavelength different from a wavelength of the light output from the light source 10. As the illumination unit 50, a white light source, a mercury lamp, a laser light source, or the like is used.

The imaging unit 60 captures an image of the micro object, which is optically trapped and driven, and is illuminated by the illumination unit 50, through the objective lens 30, the dichroic mirror 40, and the lens 33, and outputs image data. As the imaging unit 60, a CCD camera, a CMOS camera, or the like is used. The dichroic mirror 40 transmits the light from the sample 90 which is illuminated by the illumination unit 50.

The control unit 70 analyzes the motion of the micro object based on the image data output from the imaging unit 60. The control unit 70 adjusts the phase distribution of the optical vortex generated by the optical vortex generation unit 20 based on the analysis result, and controls the motion of the micro object. As the control unit 70, a computer or the like is used.

The control unit 70 includes a processing unit including, for example, a CPU, a FPGA, or the like for performing the analysis of the motion of the micro object, the adjustment of the optical vortex generation, and the like, a display unit including, for example, a liquid crystal display or the like for displaying the state of the motion of the micro object imaged by the imaging unit 60, a modulation pattern for the optical vortex generation, an adjustment pattern for the adjustment, and the like, an input unit including, for example, a keyboard, a mouse, and the like for receiving an adjustment condition of the optical vortex generation, an instruction of an adjustment start, and the like, and a storage unit including a hard disk drive, a RAM, and the like for storing programs of processing performed by the processing unit, various data, and the like.

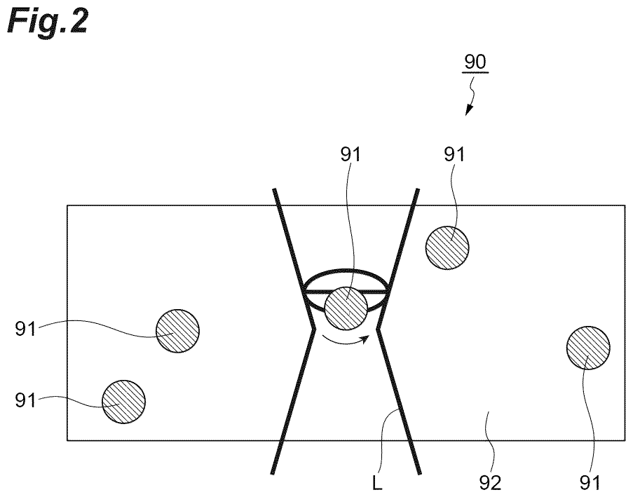

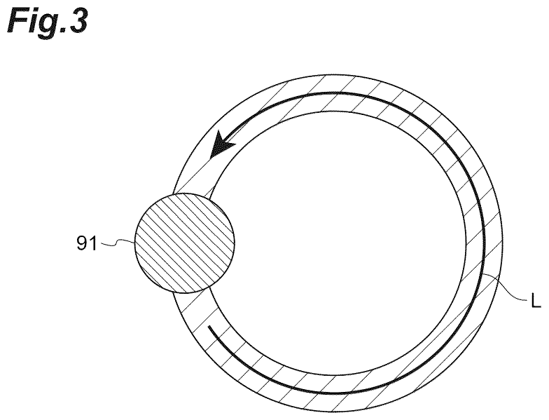

FIG. 2 and FIG. 3 are diagrams for describing the optical trap of the micro object 91 by the optical vortex. FIG. 2 illustrates a diagram as viewed in a direction perpendicular to a propagation axis of the optical vortex L. FIG. 3 illustrates a diagram as viewed in a propagation axis direction of the optical vortex L, and a doughnut-shaped region in which the light intensity of the optical vortex L is large is indicated by hatching. When the optical vortex L is focused and applied on the sample 90, the optical vortex L is capable of optically trapping the micro object 91 within the medium 92 in the sample 90, as well as causing the micro object 91 to rotate around the propagation axis. The rotational motion of the micro object 91 is, for example, a circular motion or an elliptical motion.

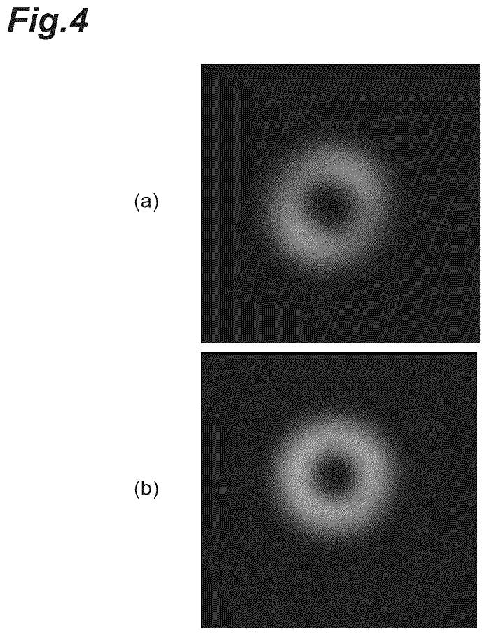

(a) and (b) in FIG. 4 are diagrams each showing an example of the intensity distribution of the optical vortex at the sample position. In these diagrams, the light intensity on a plane perpendicular to the propagation axis is indicated by grayscale, and the closer to white, the larger the light intensity.

As shown in these diagrams, the optical vortex has the doughnut-shaped light intensity distribution in which the light intensity is at a maximum at a certain distance from the propagation axis in the radial direction. Both of the light intensity distributions shown in (a) and (b) in FIG. 4 are intended to generate a light intensity distribution having a perfect circle shape in which the light intensity is at a maximum at a constant distance from the propagation axis in the radial direction, and thus, intended to move the optically trapped micro object on an orbit having a perfect circle shape.

However, the light intensity distribution shown in (a) in FIG. 4 has a lower circularity than the light intensity distribution shown in (b) in FIG. 4, and as a result, a motion trajectory of the optically trapped micro object is significantly different from the perfect circle. The reason why the light intensity distribution is different from the desired distribution is considered to be aberrations of the optical system caused by a performance of an optical component constituting the optical system of the optical vortex control apparatus and limitation of an adjustment accuracy at the time of optical system construction.

In the present embodiment, the light intensity distribution at the sample position is brought closer to the desired distribution by correcting the aberration of the optical system based on the motion information of the optically trapped micro object. An optical vortex control method of the present embodiment includes an imaging step and a control step.

In the imaging step, the micro object which is optically trapped and driven is imaged by the imaging unit 60, and image data is output. In the control step, the motion of the micro object is analyzed based on the image data, and the phase distribution of the optical vortex generated by the optical vortex generation unit 20 is adjusted based on the analysis result.

In addition, the optical vortex generation unit 20 may include one spatial light modulator, or may include two spatial light modulators which are optically coupled in series. In the case in which the optical vortex generation unit 20 includes the one spatial light modulator, an adjustment pattern (phase distribution) for optical vortex generation adjustment obtained based on the analysis result of the motion of the micro object may be superimposed on a modulation pattern for optical vortex generation before the adjustment, and the modulation pattern after the superimposition may be presented on the one spatial light modulator.

Further, in the case in which the optical vortex generation unit 20 includes the two spatial light modulators, the modulation pattern for the optical vortex generation before the adjustment may be presented on one spatial light modulator, and the adjustment pattern (phase distribution) for the optical vortex generation adjustment obtained based on the analysis result of the motion of the micro object may be presented on the other spatial light modulator.

In the control step, the control unit 70 preferably analyzes any one of a motion trajectory, a position distribution, and a torque distribution of the micro object as the motion of the micro object. Further, a sum of squares of a difference between the motion trajectory of the micro object and the desired trajectory may be analyzed as the motion of the micro object, and an arbitrary parameter relating to the motion can be analyzed.

Further, in the control step, the control unit 70 preferably analyzes any one of a velocity distribution and an angular velocity of the micro object as the motion of the micro object. Further, in the control step, the control unit 70 preferably performs the analysis based on a function in which any one of the motion trajectory, the position distribution, the velocity distribution, the angular velocity, and the torque distribution of the micro object is a variable as the motion of the micro object.

In the analysis of the motion trajectory of the micro object, for example, the motion trajectory of the micro object acquired based on the image data is approximated by an elliptical shape, and an ellipticity, which is a ratio between a minor axis length and a major axis length of the elliptical shape, is obtained. In the analysis of the position distribution of the micro object, for example, the position distribution of the micro object in a circumferential direction around the propagation axis is obtained by dividing the circumferential direction around the propagation axis into a plurality of sections for each predetermined angle and obtaining the section, out of the plurality of sections, in which the micro object exists in each frame of the image data.

Further, in the analysis of the torque distribution of the micro object, for example, the torque distribution of the micro object in the circumferential direction around the propagation axis is obtained by dividing the circumferential direction around the propagation axis into the plurality of sections for each predetermined angle and obtaining the torque of the micro object in each of the plurality of sections based on the image data.

In the case in which the micro object is revolving in orbit, an average angular velocity ω, a torque N, and a viscous drag coefficient Γ have a relationship expressed by the following Formula (1). The viscous drag coefficient Γ is determined from a statistical variance of the angular velocity according to the fluctuation dissipation theorem of Brownian motion.

$$\begin{matrix}[ Formula 1 ] & \\ N = Γ ω & ( 1 )\end{matrix}$$

When a statistical set {ωᵢ} (i=1, 2, . . . , M) of the angular velocity information of the micro object indicating the Brownian motion of a circular orbit under a constant revolving force is given, the fluctuation dissipation theorem is expressed by the following Formula (2) and Formula (3). T is an absolute temperature, k_{B} is the Boltzmann constant, and Δω is a variance of the angular velocity. In addition, correction may be performed by calculating a correct angular velocity variance from the experimental data.

$$\begin{matrix}[ Formula 2 ] & \\ \frac{2 {k}_{B} T}{Γ} = 〈 Δ {ω}^{2} 〉 & ( 2 )\end{matrix}$$

The imaging unit 60 acquires the image data at a predetermined frame rate by a plurality of pixels arrayed two-dimensionally on an imaging plane for receiving the light from the micro object. The motion information of the micro object is acquired based on the above image data, and thus, it is preferable that the following relationship exists between an exposure time of each frame and the motion of the micro object.

A centroid position of the micro object is obtained by calculating center-of-gravity on the image of the micro object in the image of each frame. However, when the exposure time of each frame is too long, a moving distance of the micro object during the exposure becomes long, and the image of the micro object extends in a moving direction, and in this case, it is difficult to accurately obtain the centroid position of the micro object.

Therefore, in order to accurately obtain the centroid position of the micro object, it is preferable that the moving distance of the micro object within the exposure time is smaller than a size of the image of the micro object on the image of each frame. By calculating center-of-gravity, the position information of the micro object can be acquired with an accuracy of the diffraction limit or less. In addition, the moving distance of the micro object within the exposure time depends on a light amount of the optical vortex.

Further, a velocity vector of the micro object can be obtained based on the centroid position of the micro object in the image of each of the frame at a certain time t1 and the frame at a next time t2, and in addition, a velocity vector distribution of the micro object in the circumferential direction can be obtained. However, when a difference between the time t1 and the time t2 is too large, it is difficult to distinguish a direction of the rotation of the micro object (whether it is clockwise or counterclockwise).

Therefore, in order to distinguish the rotational direction of the micro object, a product of the average angular velocity of the rotational motion of the micro object and the exposure time of each frame is preferably smaller than 180°.

In the control step, the control unit 70 uses any one or a plurality of analysis results out of the above analysis results. In the case in which the one analysis result is used, the optical vortex generation by the optical vortex generation unit 20 is adjusted such that an evaluation value based on the analysis result is minimized. Further, in the case in which the plurality of analysis results are used, for example, a linear sum of the evaluation values based on the respective analysis results is set as an evaluation function, and the optical vortex generation by the optical vortex generation unit 20 is adjusted such that the value of the evaluation function is minimized.

For example, in the case in which it is desired to revolve the micro object on an orbit of a perfect circle at a constant speed, an ellipticity evaluation value A indicating the deviation of the motion trajectory of the micro object from the perfect circle is obtained based on the ellipticity, and further, a variance evaluation value B indicating the degree of variation of the speed of the motion of the micro object is obtained based on the variance value of the position distribution or the torque distribution of the micro object. Further, an evaluation function expressed by a formula of αA+βB is obtained by using coefficients α and β. Further, the optical vortex generation by the optical vortex generation unit 20 is adjusted such that the value of the evaluation function is minimized.

In the control step, at the time of obtaining the adjustment pattern for the optical vortex generation adjustment by the optical vortex generation unit 20 based on the analysis result, the control unit 70 preferably represents the adjustment pattern by using the Zernike polynomials, and further, preferably obtains the adjustment pattern by using an optimization method.

The Zernike polynomials are orthogonal polynomials defined on the unit circle, and are represented by two indices (non-negative integer n, integer m) and two variables (radial index p, azimuthal index ¢). The Zernike polynomial is used in the case of, in particular, analytically handling axisymmetric optical aberrations based on the diffraction theory in the field of optics. Further, the Zernike polynomial may be used in the case of representing an aberration correction pattern.

As the optimization method, for example, a simulated annealing method, a genetic algorithm, a blind search, or the like can be used. In the case in which the aberration correction amount is represented by a linear sum of a plurality of aberration components, a coefficient of each of the aberration components can be obtained by using the optimization method.

In the control step, the control unit 70 superimposes the adjustment pattern for the optical vortex generation adjustment obtained based on the analysis result of the motion of the micro object on the modulation pattern for the optical vortex generation before the adjustment, and causes the optical vortex generation unit 20 to present the modulation pattern after the superimposition. By using the above configuration, the control unit 70 can control the motion of the micro object by adjusting the optical vortex generation performed by the optical vortex generation unit 20. The adjustment pattern may include both the amplitude distribution and the phase distribution, and in addition, can be set to a pattern including only the phase distribution.

Next, an example will be described. In the example, in the configuration of the optical vortex control apparatus 1 illustrated in FIG. 1, for each of five objective lenses A to E which are used as the objective lens 30, the motion trajectory and the torque distribution of the micro object were obtained before and after the optical vortex generation adjustment.

Out of the five objective lenses A to E, the same person constructed the optical system of the optical vortex control apparatus 1 by using each of the four objective lenses B to E, and further, the other person constructed the optical system of the optical vortex control apparatus 1 by using the other objective lens A. Further, out of the five objective lenses A to E, the four objective lenses A to D have the same specification, and further, the other objective lens E has the different specification.

Each of the four objective lenses A to D is a plan semi apochromat objective lens in which a chromatic aberration and a field curvature aberration are corrected, and has a high transmittance in a broadband from an ultraviolet region to a near-infrared region. The plan semi apochromat objective lens has a higher specification than an achromat objective lens, and is suitable for use in the optical vortex generation. The objective lens E is the achromat objective lens in which a chromatic aberration in a visible region is corrected, and is the most common objective lens. The achromat objective lens is not suitable for the imaging because the periphery is blurred when focusing is performed on the center of the field of view.

The spatial light modulator was used as the optical vortex generation unit 20, and a hologram to be displayed was designed by using the Kirk-Jones method. As design parameters, an azimuthal index was set to 2, a radial index was set to 0, and a beam size radius was set to 2.00 mm. A radius of the optical vortex generated on the pupil plane of the objective lens is preferably 20% or more with respect to a radius of the pupil plane.

Further, in the sample 90 of the present example, a polystyrene bead having a diameter of 0.40 μm was used as the micro object 91, and pure water was used as the medium 92. A ring-shaped spacer was sandwiched with two glass plates, and the micro object and the medium were placed in a space formed by these plates. Then, the micro object (polystyrene bead) floating in the medium (pure water) was optically trapped by the optical vortex focused by the objective lens.

The optical vortex generation performed by the optical vortex generation unit 20 was adjusted such that the value of the evaluation function represented by the linear sum of the ellipticity evaluation value A and the variance evaluation value B was minimized, with the aim of moving the micro object on the orbit of the perfect circle at the constant speed. Before and after the optical vortex generation adjustment, the centroid position of the micro object in each frame of the image data was plotted as a point on an xy plane, the motion trajectory of the micro object was approximated by the elliptical orbit, and the ellipticity, which is the ratio between the minor axis length and the major axis length of the elliptical orbit, was obtained. The ellipticity evaluation value A was obtained based on the above ellipticity.

Further, before and after the optical vortex generation adjustment, the torque distribution of the micro object in the circumferential direction around the propagation axis was obtained by dividing the circumferential direction around the propagation axis into 72 sections with the predetermined angle of 5° and obtaining the torque of the micro object in each of the sections based on the image data. The variance evaluation value B was obtained based on the variance value of the above torque distribution.

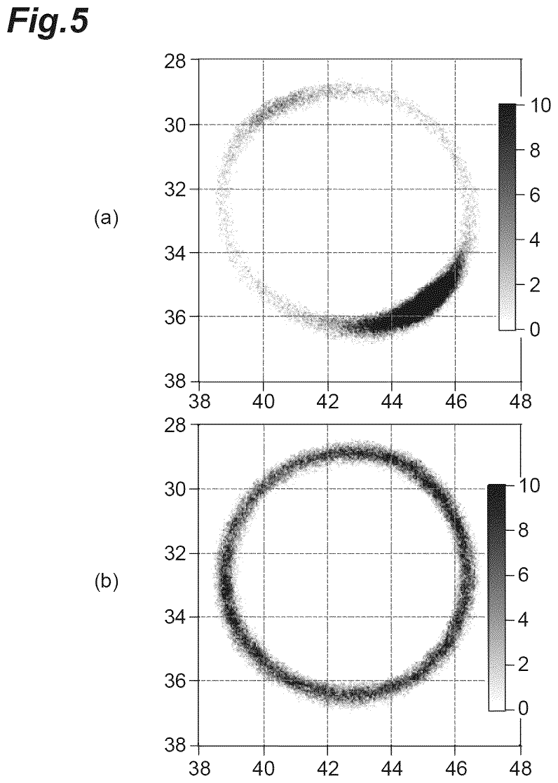

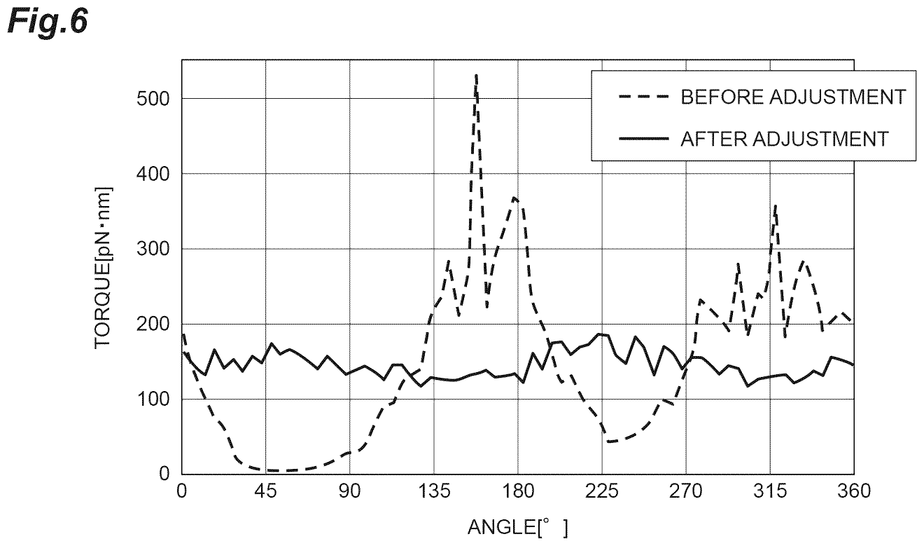

(a) in FIG. 5 is a diagram showing the motion trajectory of the micro object before the optical vortex generation adjustment in the case in which the objective lens A is used. (b) in FIG. 5 is a diagram showing the motion trajectory of the micro object after the optical vortex generation adjustment in the case in which the objective lens A is used. FIG. 6 is a graph showing the torque distribution of the micro object before and after the optical vortex generation adjustment in the case in which the objective lens A is used.

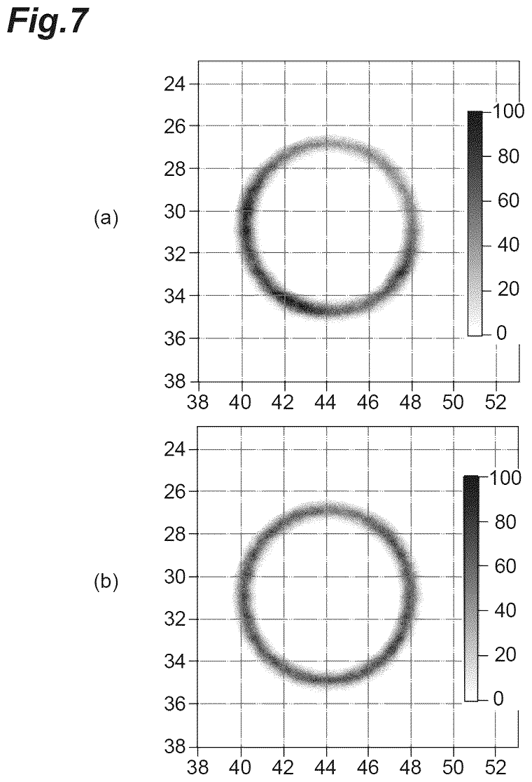

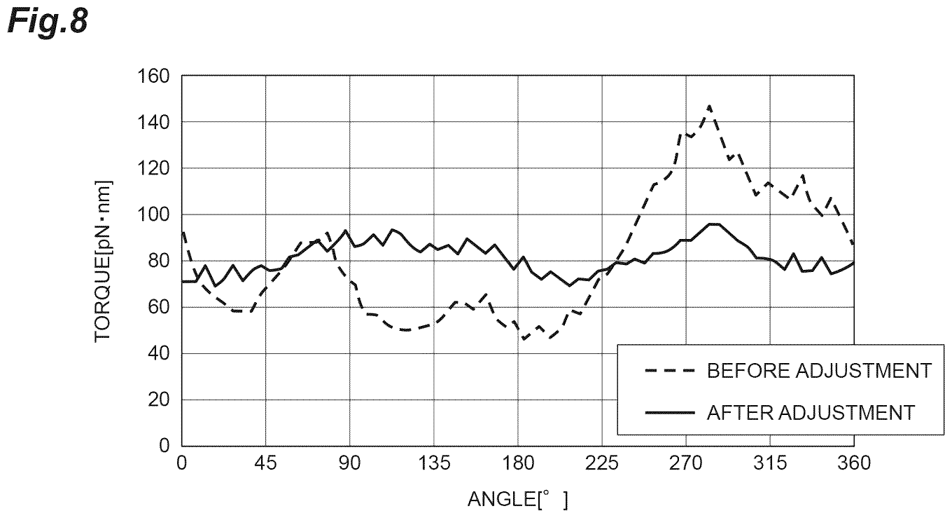

(a) in FIG. 7 is a diagram showing the motion trajectory of the micro object before the optical vortex generation adjustment in the case in which the objective lens B is used. (b) in FIG. 7 is a diagram showing the motion trajectory of the micro object after the optical vortex generation adjustment in the case in which the objective lens B is used. FIG. 8 is a graph showing the torque distribution of the micro object before and after the optical vortex generation adjustment in the case in which the objective lens B is used.

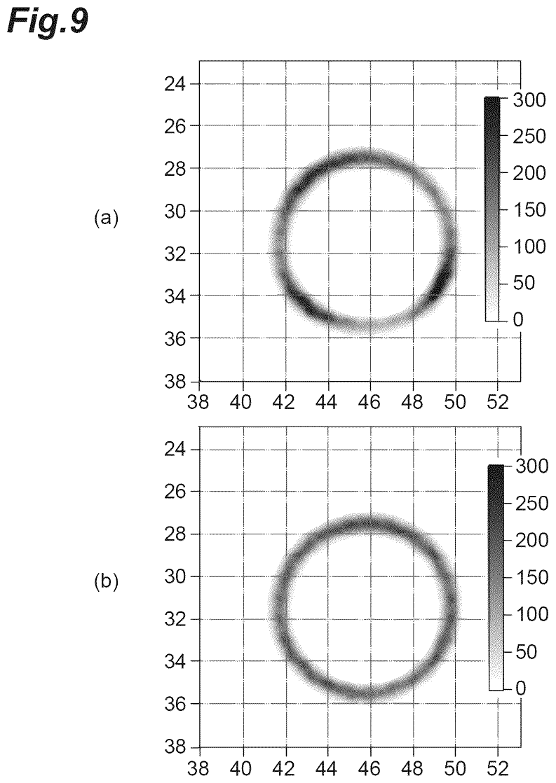

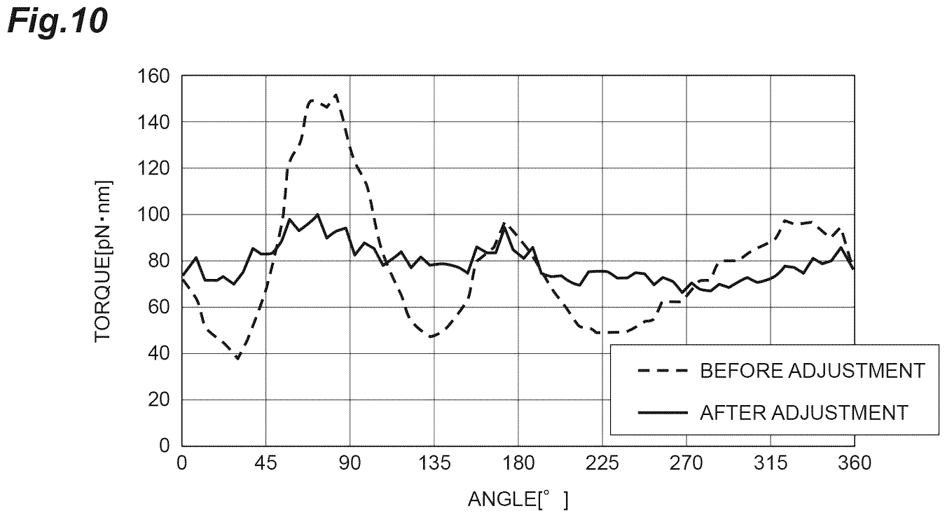

(a) in FIG. 9 is a diagram showing the motion trajectory of the micro object before the optical vortex generation adjustment in the case in which the objective lens C is used. (b) in FIG. 9 is a diagram showing the motion trajectory of the micro object after the optical vortex generation adjustment in the case in which the objective lens C is used. FIG. 10 is a graph showing the torque distribution of the micro object before and after the optical vortex generation adjustment in the case in which the objective lens C is used.

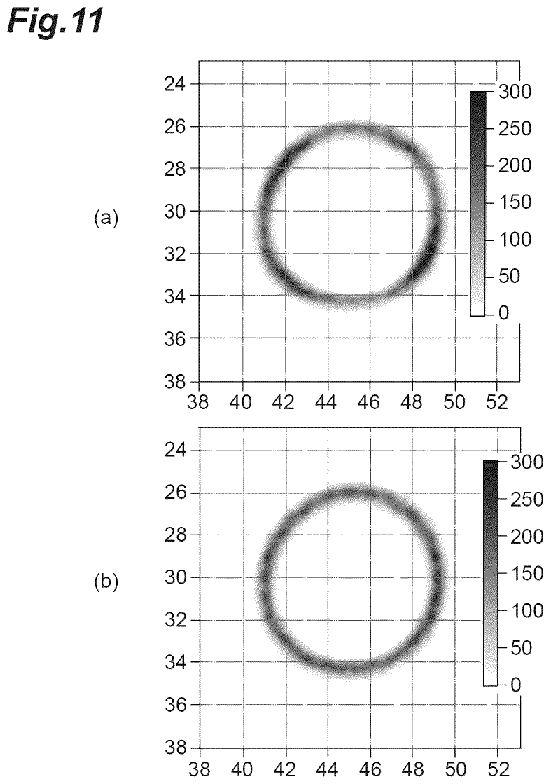

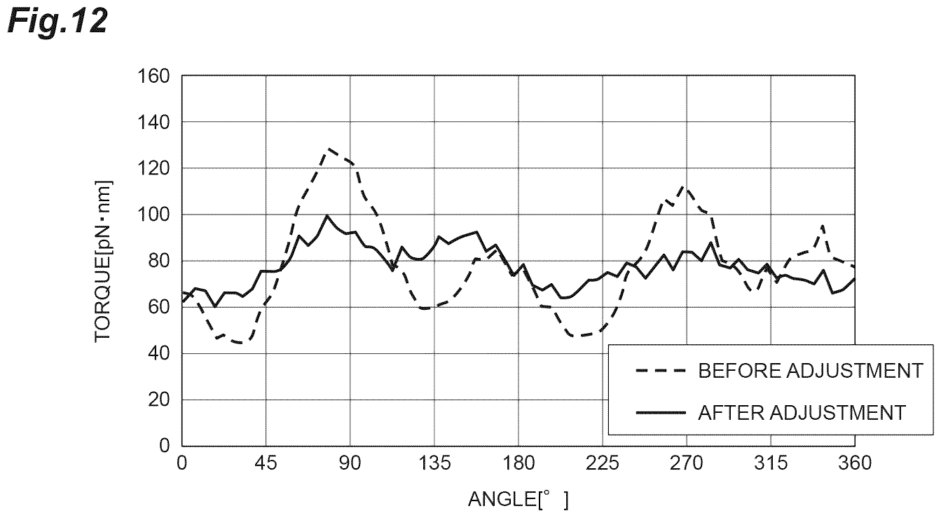

(a) in FIG. 11 is a diagram showing the motion trajectory of the micro object before the optical vortex generation adjustment in the case in which the objective lens D is used. (b) in FIG. 11 is a diagram showing the motion trajectory of the micro object after the optical vortex generation adjustment in the case in which the objective lens D is used. FIG. 12 is a graph showing the torque distribution of the micro object before and after the optical vortex generation adjustment in the case in which the objective lens D is used.

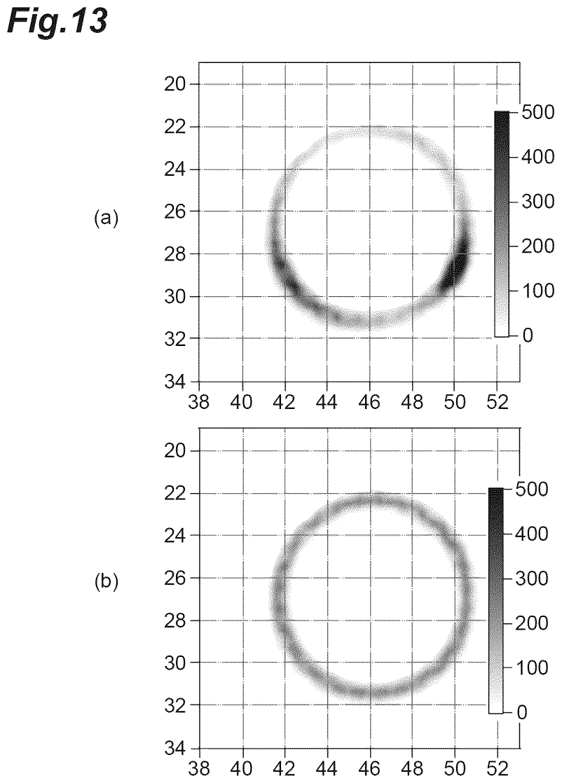

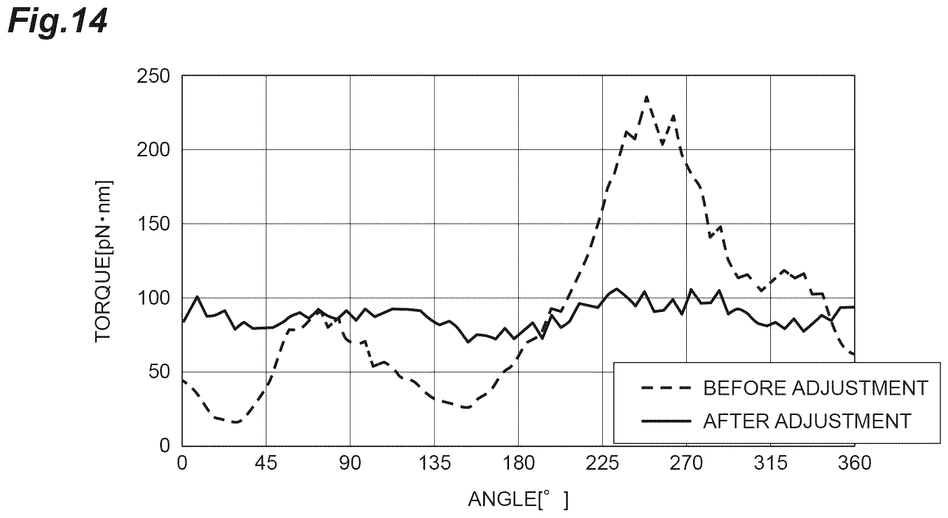

(a) in FIG. 13 is a diagram showing the motion trajectory of the micro object before the optical vortex generation adjustment in the case in which the objective lens E is used. (b) in FIG. 13 is a diagram showing the motion trajectory of the micro object after the optical vortex generation adjustment in the case in which the objective lens E is used. FIG. 14 is a graph showing the torque distribution of the micro object before and after the optical vortex generation adjustment in the case in which the objective lens E is used.

In each of (a) in FIG. 5, (b) in FIG. 5, (a) in FIG. 7, (b) in FIG. 7, (a) in FIG. 9, (b) in FIG. 9, (a) in FIG. 11, (b) in FIG. 11, (a) in FIG. 13, and (b) in FIG. 13, the centroid position of the micro object in each frame of the image data is plotted as the point on the xy plane, and a magnitude of an existence density of the points is indicated by grayscale. Each of FIG. 6, FIG. 8, FIG. 10, FIG. 12, and FIG. 14 is a graph in which the horizontal axis indicates the angle position in the circumferential direction around the propagation axis, and the vertical axis indicates the torque.

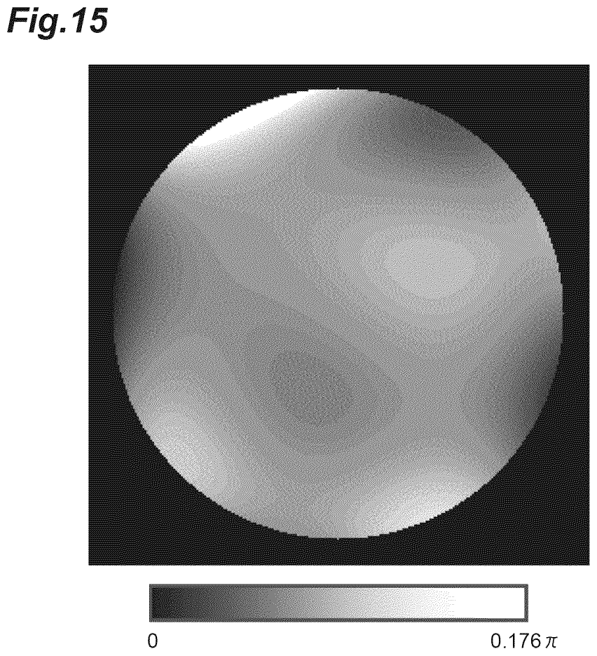

FIG. 15 is a diagram showing an example of the adjustment pattern for the optical vortex generation adjustment. The adjustment pattern in this case is the phase distribution represented by the Zernike polynomial.

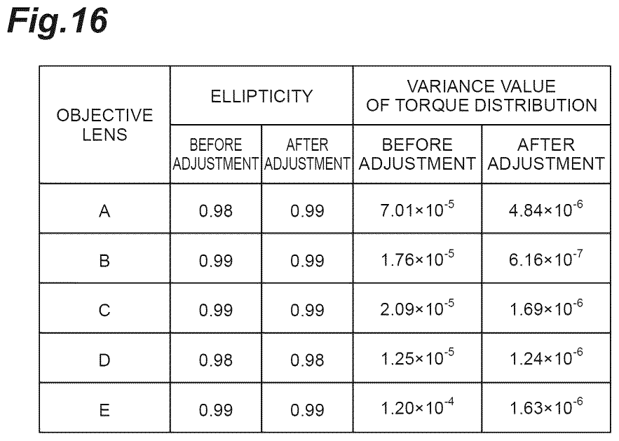

FIG. 16 is a table showing the ellipticity and the variance value of the torque distribution before and after the optical vortex generation adjustment in the case in which each of the objective lenses A to E is used. As shown in the result of the example, in the case after the optical vortex generation adjustment, compared with the case before the optical vortex generation adjustment, the ellipticity can be made closer to 1, and the motion trajectory of the micro object can be made closer to the perfect circle. Further, in the case after the optical vortex generation adjustment, compared with the case before the optical vortex generation adjustment, the variance value of the torque distribution of the micro object in the circumferential direction around the propagation axis can be made smaller, and the speed of the motion of the micro object can be made closer to the constant value.

According to the present embodiment, it is possible to easily generate and adjust the optical vortex which can bring the motion of the micro object optically trapped by the optical vortex close to the desired motion, regardless of the performance of the optical components constituting the optical system and the adjustment accuracy at the time of the optical system construction.

In the techniques described in Non Patent Documents 1 to 6, the high precision optical device and the complicated post-processing are required to acquire the intensity information of the optical vortex, and thus, the adjustment of the optical vortex generation is not easy. On the other hand, in the present embodiment, it is not necessary to acquire the intensity information of the optical vortex, and thus, the adjustment of the optical vortex generation is easy.

In the technique described in Non Patent Document 6, the adjustment of the modulation pattern which is presented in the spatial light modulator is performed with two stages of the amplitude distribution adjustment and the phase distribution adjustment, and thus, the adjustment of the optical vortex generation is not easy. On the other hand, in the present embodiment, only the phase distribution adjustment is required, and thus, the adjustment of the optical vortex generation is easy. Further, in the present embodiment, only the phase distribution adjustment is required, and thus, it is also preferable in that the loss of the light can be suppressed.

The optical vortex control apparatus and the optical vortex control method are not limited to the embodiments and configuration examples described above, and various modifications are possible.

The optical vortex control apparatus of a first aspect according to the above embodiment includes a light source for outputting light; an optical vortex generation unit for generating an optical vortex from the light; a focusing optical system for focusing the optical vortex; an imaging unit for imaging a micro object optically trapped and driven by the optical vortex focused by the focusing optical system, and outputting image data; and a control unit for analyzing a motion of the micro object based on the image data, and adjusting a phase distribution of the optical vortex generated by the optical vortex generation unit based on an analysis result.

In the optical vortex control apparatus of a second aspect, in the configuration of the first aspect, the optical vortex generation unit may include a spatial light modulator having a plurality of pixels arrayed two-dimensionally, and for modulating at least a phase of the light in each pixel, and outputting the light.

In the optical vortex control apparatus of a third aspect, in the configuration of the second aspect, the control unit may superimpose an adjustment pattern for optical vortex generation adjustment on a modulation pattern for optical vortex generation, and cause the spatial light modulator to present the modulation pattern after superimposition.

In the optical vortex control apparatus of a fourth aspect, in the configuration of the third aspect, the control unit may obtain the adjustment pattern as a phase distribution.

In the optical vortex control apparatus of a fifth aspect, in the configuration of the third or fourth aspect, the control unit may obtain the adjustment pattern by using a Zernike polynomial.

In the optical vortex control apparatus of a sixth aspect, in the configuration of any one of the third to fifth aspects, the control unit may obtain the adjustment pattern by using an optimization method.

In the optical vortex control apparatus of a seventh aspect, in the configuration of any one of the first to sixth aspects, the control unit may analyze any one of a motion trajectory, a position distribution, and a torque distribution of the micro object as the motion of the micro object.

In the optical vortex control apparatus of an eighth aspect, in the configuration of any one of the first to sixth aspects, the control unit may analyze any one of a velocity distribution and an angular velocity of the micro object as the motion of the micro object.

In the optical vortex control apparatus of a ninth aspect, in the configuration of any one of the first to sixth aspects, the control unit may perform analysis based on a function in which any one of a motion trajectory, a position distribution, a velocity distribution, an angular velocity, and a torque distribution of the micro object is a variable as the motion of the micro object.

The optical vortex control method of a first aspect according to the above embodiment uses a light source for outputting light; an optical vortex generation unit for generating an optical vortex from the light; and a focusing optical system for focusing the optical vortex, and the optical vortex control method includes an imaging step of imaging, by an imaging unit, a micro object optically trapped and driven by the optical vortex focused by the focusing optical system, and outputting image data; and a control step of analyzing a motion of the micro object based on the image data, and adjusting a phase distribution of the optical vortex generated by the optical vortex generation unit based on an analysis result.

In the optical vortex control method of a second aspect, in the configuration of the first aspect, the optical vortex generation unit may include a spatial light modulator having a plurality of pixels arrayed two-dimensionally, and for modulating at least a phase of the light in each pixel, and outputting the light.

In the optical vortex control method of a third aspect, in the configuration of the second aspect, in the control step, an adjustment pattern for optical vortex generation adjustment may be superimposed on a modulation pattern for optical vortex generation, and the modulation pattern after superimposition may be presented on the spatial light modulator.

In the optical vortex control method of a fourth aspect, in the configuration of the third aspect, in the control step, the adjustment pattern may be obtained as a phase distribution.

In the optical vortex control method of a fifth aspect, in the configuration of the third or fourth aspect, in the control step, the adjustment pattern may be obtained by using a Zernike polynomial.

In the optical vortex control method of a sixth aspect, in the configuration of any one of the third to fifth aspects, in the control step, the adjustment pattern may be obtained by using an optimization method.

In the optical vortex control method of a seventh aspect, in the configuration of any one of the first to sixth aspects, in the control step, any one of a motion trajectory, a position distribution, and a torque distribution of the micro object may be analyzed as the motion of the micro object.

In the optical vortex control method of an eighth aspect, in the configuration of any one of the first to sixth aspects, in the control step, any one of a velocity distribution and an angular velocity of the micro object may be analyzed as the motion of the micro object.

In the optical vortex control method of a ninth aspect, in the configuration of any one of the first to sixth aspects, in the control step, analysis may be performed based on a function in which any one of a motion trajectory, a position distribution, a velocity distribution, an angular velocity, and a torque distribution of the micro object is a variable as the motion of the micro object.

### INDUSTRIAL APPLICABILITY

The embodiments can be used as an optical vortex control apparatus and an optical vortex control method capable of easily generating a desired optical vortex.

### REFERENCE SIGNS LIST

1—optical vortex control apparatus, 10—light source, 20—optical vortex generation unit, 30-33—lens, 34—aperture, 40—dichroic mirror, 50—illumination unit, 60—imaging unit, 70—control unit, 90—sample, 91—micro object, 92—medium.

1. An optical vortex control apparatus comprising:
a light source configured to output light;
an optical vortex generator configured to generate an optical vortex from the light;
a focusing optical system configured to focus the optical vortex;
an imager configured to image a micro object optically trapped and driven by the optical vortex focused by the focusing optical system, and output image data; and
a controller configured to analyze a motion of the micro object based on the image data, and adjust a phase distribution of the optical vortex generated by the optical vortex generator based on an analysis result.

2. The optical vortex control apparatus according to claim 1, wherein the optical vortex generator includes a spatial light modulator having a plurality of pixels arrayed two-dimensionally, and configured to modulate at least a phase of the light in each pixel, and output the light.

3. The optical vortex control apparatus according to claim 2, wherein the controller is configured to superimpose an adjustment pattern for optical vortex generation adjustment on a modulation pattern for optical vortex generation, and cause the spatial light modulator to present the modulation pattern after superimposition.

4. The optical vortex control apparatus according to claim 3, wherein the controller is configured to obtain the adjustment pattern as a phase distribution.

5. The optical vortex control apparatus according to claim 3, wherein the controller is configured to obtain the adjustment pattern by using a Zernike polynomial.

6. The optical vortex control apparatus according to claim 3, wherein the controller is configured to obtain the adjustment pattern by using an optimization method.

7. The optical vortex control apparatus according to claim 1, wherein the controller is configured to analyze any one of a motion trajectory, a position distribution, and a torque distribution of the micro object as the motion of the micro object.

8. The optical vortex control apparatus according to claim 1, wherein the controller is configured to analyze any one of a velocity distribution and an angular velocity of the micro object as the motion of the micro object.

9. The optical vortex control apparatus according to claim 1, wherein the controller is configured to perform analysis based on a function in which any one of a motion trajectory, a position distribution, a velocity distribution, an angular velocity, and a torque distribution of the micro object is a variable as the motion of the micro object.

10. An optical vortex control method using a light source configured to output light; an optical vortex generator configured to generate an optical vortex from the light; and a focusing optical system configured to focus the optical vortex, the optical vortex control method comprising:
performing an imaging of imaging, by an imager, a micro object optically trapped and driven by the optical vortex focused by the focusing optical system, and outputting image data; and
performing a control of analyzing a motion of the micro object based on the image data, and adjusting a phase distribution of the optical vortex generated by the optical vortex generator based on an analysis result.

11. The optical vortex control method according to claim 10, wherein the optical vortex generator includes a spatial light modulator having a plurality of pixels arrayed two-dimensionally, and configured to modulate at least a phase of the light in each pixel, and output the light.

12. The optical vortex control method according to claim 11, wherein in the control, an adjustment pattern for optical vortex generation adjustment is superimposed on a modulation pattern for optical vortex generation, and the modulation pattern after superimposition is presented on the spatial light modulator.

13. The optical vortex control method according to claim 12, wherein in the control, the adjustment pattern is obtained as a phase distribution.

14. The optical vortex control method according to claim 12, wherein in the control, the adjustment pattern is obtained by using a Zernike polynomial.

15. The optical vortex control method according to claim 12, wherein in the control, the adjustment pattern is obtained by using an optimization method.

16. The optical vortex control method according to claim 10, wherein in the control, any one of a motion trajectory, a position distribution, and a torque distribution of the micro object is analyzed as the motion of the micro object.

17. The optical vortex control method according to claim 10, wherein in the control, any one of a velocity distribution and an angular velocity of the micro object is analyzed as the motion of the micro object.

18. The optical vortex control method according to claim 10, wherein in the control, analysis is performed based on a function in which any one of a motion trajectory, a position distribution, a velocity distribution, an angular velocity, and a torque distribution of the micro object is a variable as the motion of the micro object.
